(19) United States
(12) Patent Application Publication
(10) Pub. No.: US 2005/0120100 A1
(43) Pub. Date: Jun. 2, 2005

(54) Method and system for updating synchronization status of managed objects

(76) Inventors: Daniel Dufour, Blainville (CA); Andre Godin, Laval (CA)

Correspondence Address: ALEX NICOLAESCU;Ericsson Canada Inc., Patent Department (LMC/M/P), 8400 Decarie Blvd., Town Mount Royal, H4P 2N2, CA

(21) Appl. No.: 10/724,195

(22) Filed: Dec. 1, 2003

(51) Int. Cl. G06F 15/177

(52) U.S. Cl. 709/222; 709/223

(57) ABSTRACT

A method and manager node for setting a synchronization status of a Managed Object (MO) based on an outcome of synchronization between the manager and a related Network Element (NE). An attribute of a management system's first MO that represents a first NE of a managed network is changed in the manager. Responsive to the attribute change, and because the first NE is related to a second NE of the managed network, the manager initiates an update of a second NE of the managed network for propagating the change to that second NE, in addition to updating the first NE, and further determines whether or not the update of the second NE has been completed successfully. The manager sets a synchronization attribute of a second MO that represents the second NE in the management system to a value representative of an outcome of the update of the second NE.

### BACKGROUND OF THE INVENTION

1. Field of the Invention

The present invention relates to a method and system for updating a synchronization status of a Managed Object (MO) of a management system.

2. Description of the Related Art

Management systems are well known in the art. They are used for monitoring and managing the quality of communications over various networks, such as for example Local Area Networks (LANs), Wide Area Networks (WANs), Public Local Mobile Networks (PLMNs), and Public Switching Telephone Networks (PSTNs), hereinafter designated as the managed or monitored networks. Exemplary functions of a typical management system comprise, but are not limited to, providing configuration and status information about Network Elements (NEs) or NEs' components, collecting alarm/event notifications, correlating the alarm/event notifications with each other, diagnosing and repairing errors and malfunctions. In such systems, pieces of information called events (or event notifications or alarms) are issued by the NEs of the managed network and acquired by the management system, which is responsible of their treatment. The information issued by the processing of the alarm/event notifications may be monitored, either automatically or by system administrators, with the general purpose of maintaining or increasing the quality of the communications of the managed network. On the other side, another function of the management system comprises updating configuration attributes related to the managed network's elements using a user interface, and deploying the updates toward the managed network's elements.

Reference is now made to FIG. 1 (Prior Art), which is a high-level network diagram of a management system 100 which function is to manage a Public Local Mobile Network (PLMN) 102. The PLMN 102 may comprise, as it is well known in the art, a plurality of base stations 104-107, which provide cellular radio service to a plurality of mobile stations 108-119 via associated radio interfaces. The base stations 104-107 are connected to a Base Station Controller 1 (BSC 1) 120, which in turn connects to a Mobile Switching Center 1 (MSC 1) 122. The PLMN 102 may further comprise a second MSC, called MSC 2 124, and a second BSC, called BSC 2 126, as well as a Gateway GPRS Support Node (GGSN) 127, a Serving GPRS Support Node (SGSN) 128 and an associated Base Station Subsystem (BSS) 130. According to the exemplary PLMN 102 shown in FIG. 1, each Network Element (NE) of the managed network (the PLMN 102), comprises a management Agent (Agent 1 to Agent 7) responsible for maintaining management information about the NE that stores it. The management information of each Agent may comprise configuration and status information about the particular NE and its components and connections. Each such NE Agent connects via management links 111 (shown in double line) to a Manager 160 of the management system 100, which function is to collect events and alarm notifications 150, 152, and 154 issued by the NEs' Agents 1-7 121, 123, 125, 127, 129, 131, and 133 of the managed system 102. The Manager 160 receives the alarm and events notifications 150, 152, and 154 from the monitored system 102 and may further process, correlate, and adapts the received information into a format compatible and suitable for viewing by a variety of system administrators' terminals 162-168 of the management system 100. A further function of the Manager 160 is to allow for the updating of configuration attributes related to any one or more of the managed NEs, using the terminals 162-168, and to deploy the updated attributes to the NEs, such as shown in the exemplary actions 180, 182, 184.

In a typical management system, the management information stored in the Manager 160 comprises virtual entities known as Managed Objects (MOs), which are virtual representations of the managed network's Network Elements (NEs), or NEs' components. For example, the NE BSC 1 120 is represented in the Manager 160 as an MO. Furthermore, the NE BSC 1 120 may comprise a plurality of NE components, such as for example radio controllers 170-179, which are also represented in the Manager 160 as a corresponding plurality of MOs 170′-179′, that depend upon the high level MO corresponding to BSC 1120.

Such a virtual representation of each NE and NE component of the managed network 102 allows system administrators of terminals 162-168 to be able to view and edit the related attributes of each MO, which updates are then deployed as configuration attributes to corresponding NEs in the managed network 102. In this manner, system administrators are able to monitor and improve the quality of the communications of the managed network 102.

Reference is now made to FIG. 2 (Prior Art), which shows a high-level block diagram of a management Agent of an NE of a managed network, such as for example of the Agent 121 of the NE BSC 1 120, previously described with reference to FIG. 1. The Agent 121 is a functionality of the NE BSC 1 120, which function is to store configuration and status information regarding the functioning of the NE BSC 1 120, its components and connections. For this purpose, the Agent 1 121 comprises a Management Information Base (MIB) 200, which may comprise any kind of memory or database that stores local management information about the NE BSC 1 120. For example, the MIB 200 may store a list of a plurality of components 202-206 of the BSC 1 120, along with their associated status information 208 and attribute values 210-214. The MIB 200 may further store a list of connections 216-220 of the BSC 1 120, along with their corresponding status 222, and attribute values 224-228.

While the NEs of the managed network 102, such as the BSC 1 120 (shown in FIG. 1) comprise an Agent with a MIB for storing only local configuration and status information, the Manager 160 is in charge of managing the entire managed network 102 and therefore comprises its own MIB that stores management information about each one of the managed NEs of the managed network. The Manager's information typically takes the form of Managed Objects (MOs). In most situations, the Manager 160 maintains a Master-Slave relationship with the plurality of NE of the managed network, so that every configuration and status update that is performed in the management information stored in the Manager is propagated into the corresponding NE(s) of the managed network 102, and has precedence over any local configuration or status parameter of that/those NE(s).

Reference is now made to FIG. 3 (Prior Art) that is a high-level block diagram of a Manager alike the Manager 160. The Manager 160 comprises its own MIB 300 storing, for example, a first MO 302 with a MIB relative to the Agent 1 121 of the NE BSC 1 120, and a second MO 304 with a MIB relative to the Agent 2 127 of the BSC 2 126. Each such MIB comprises management information 306 and 308 relative to the appropriate Agent of the managed network, and a synchronization status 310 and 312 indicative of a current status of synchronization between the given MO of the Manager 160 and its corresponding NE's MIB from the managed network. For example, the synchronization status 310 of the MO 302 may be “In SYNCH”, which is indicative that the management information 306 of the MO 302 stored in the Manager 160 is currently synchronized with the management information stored in the MIB 200 of the Agent 1 121 of the NE BSC 1 120 (Agent 121 is shown in FIG. 2). This normally happens once an update of configuration and/or status information regarding the Agent is successfully propagated from the Manager 160 to the Agent 121 in the managed network, so that the management information of the MIB 200 of the NE is synchronized with the management information of the MIB 302 of the Manager 160.

However, it has been noticed that in various instances it is not sufficient to have a perfect synchronization between the management information relative to a given MO of the Manager and its corresponding NE of the managed network. For example, updates of an MO's attributes performed in the Manager's MIB may not only need to be propagated to the corresponding NE, but also to other NEs of the managed network. An instance wherein this situation occurs is, for example, when a system administrator updates a radio channel attribute relative to a component (e.g. a radio cell) of the MO 302 that represents the NE BSC 1 120 of the managed network. Since a radio channel attribute has been changed, such change not only affects the corresponding NE BSC 1 120 but also its neighbour BSC that controls the cells that are adjacent to the radio cell which radio channel attribute has been changed. In the present exemplary scenario, it is assumed that the NE BSC 2 126 is the BSC that controls a neighbouring radio cell of the given cell, and therefore, the update of the radio channel attribute needs also to be propagated to the NE BSC 2 126 (better shown in FIG. 1).

However, current management systems not always perform this task. Furthermore, even when they perform synchronization of a given MO of a Manager with multiple NEs of the managed network, current management systems fail to set the MO's synchronization status within the Manager based on the result of the synchronization process with the multiple Agents from the managed network. In current management systems it is rather only the result of a single synchronization of one MO with its corresponding NE that yields the synchronization status of the MO, i.e. if the single synchronization between the MO and its NE is successful, the MO's synchronization status is set to “IN SYNCH”.

Although there is no prior art solution as the one proposed hereinafter for solving the above-mentioned deficiencies, the U.S. Pat. No. 6,041,342 issued to Yamaguchi on Mar. 21, 2000 (hereinafter called Yamaguchi) bears some relation with the field of the present invention. Yamaguchi teaches a synchronization process between a management station and an agent station, wherein responsive to an execution request message sent from the management station to the agent station, the latter estimates the time required for execution of a synchronization and informs the management station. At the expiration of the time period, the management station inquires about the status of the synchronization, and receives another time estimate from the agent station. If the time estimate is zero, the management station concludes that the synchronization process is completed. Otherwise, the management station waits for the length of the second time estimate, and concludes the synchronization process at its expiration.

Yamaguchi only deals with a process for limiting the time required for a synchronization of a management station with an agent station. Therefore, Yamaguchi fails to teach or suggest a method and system for updating synchronization status information of a manager's MO based on synchronization between the manager and multiple agents.

The U.S. Patent Application U.S. 2002/0120733 published in the name of Kring on Aug. 29, 2002 (hereinafter called Kring) also bears some relation with the field of the present invention. Kring teaches a method, program, and system for synchronizing a network manager with an agent, wherein the agent stores three different values. The first value is unique, the second value indicates the number of changes performed to the associated data unit, while the third value indicates the identity of the initiator of the last change to the data unit. A copy of the three values is also stored in the manager and is compared with the agent's three values. When the agent and manager's values do not match, the three values of the manager are synchronized with the three values of the agent.

The teaching of Kring is limited to synchronizing three different values between one agent and one manager. Hence, Kring also fails to teach or suggest a method and system for updating synchronization status information of a manager's MO based on synchronization between the manager and multiple agents.

Accordingly, it should be readily appreciated that in order to overcome the deficiencies and shortcomings of the existing solutions, it would be advantageous to have a method and system for effectively allowing the update of synchronization status information of a manager's MIB based on synchronization processes with multiple agents.

### SUMMARY OF THE INVENTION

In one aspect, the present invention is a method for setting a synchronization status to a Managed Object (MO) of a management system, the method comprising the steps of:
a. changing an attribute of a management system's first MO that represents a first Network Element (NE) of a managed network;
b. responsive to the attribute change, initiating an update of a second NE of the managed network for propagating the change to the second NE, wherein the first and the second NEs are related NEs;
c. determining whether or not the update of the second NE has been completed successfully; and
d. setting a synchronization attribute of the second MO to a value representative of an outcome of the update of the second NE.

In another aspect, the present invention is a manager of a management system comprising:
a first Management Object (MO) that represents a first Network Element (NE) of a managed network;
a second MO that represents a second NE of the managed network, the first and the second NEs being related NEs
wherein when an attribute of the first MO is changed in the manager, the manager initiates an update of the second NE for propagating the change to the second NE, determines whether or not the update of the second NE has been completed successfully, and sets a synchronization attribute of the second MO to a value representative of an outcome of the update of the second NE.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a high-level network diagram of a typical management system that manages a Public Local Mobile Network (PLMN);

FIG. 2 (Prior Art) is a high-level block diagram of a typical management Agent of a Network Element (NE) of a managed network;

FIG. 3 (Prior Art) is a high-level block diagram of a typical Manager of a management system; and

FIG. 4 is an exemplary high-level representation of two neighbouring NEs of a managed network;

FIG. 5 is an exemplary high-level block diagram of a Manager that manages two different NEs according to the preferred embodiment of the present invention; and

FIG. 6 is an exemplary flowchart diagram of a method for updating synchronization status information according to the preferred embodiment of the present invention.

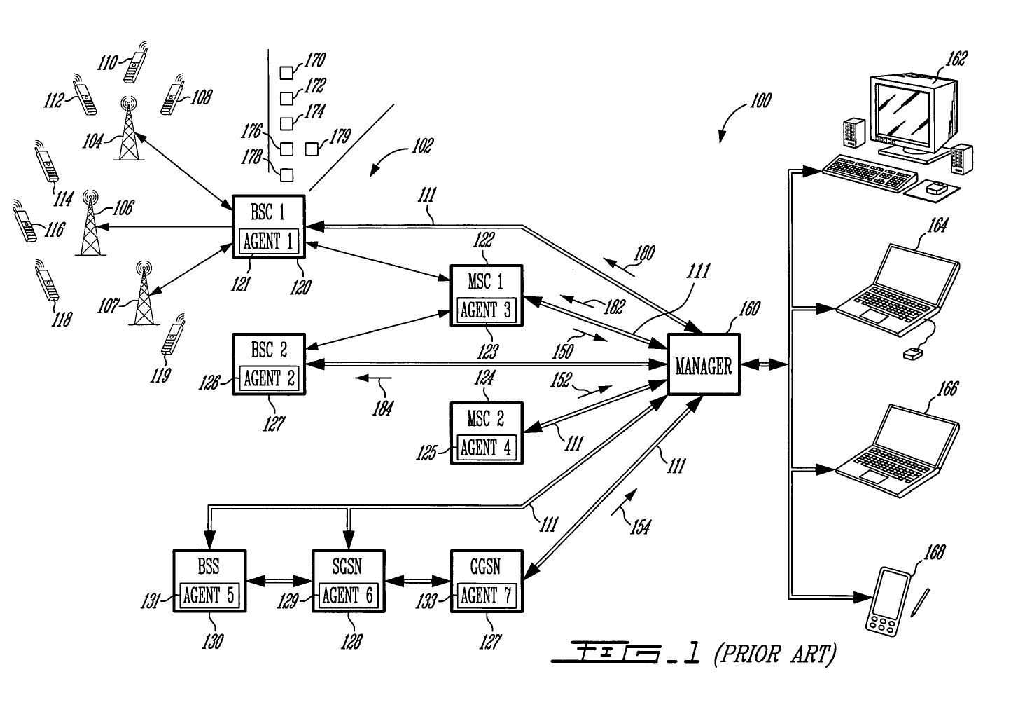

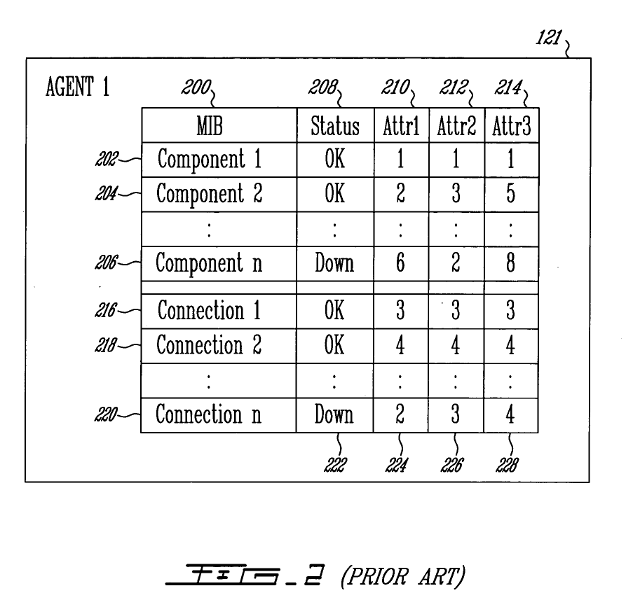

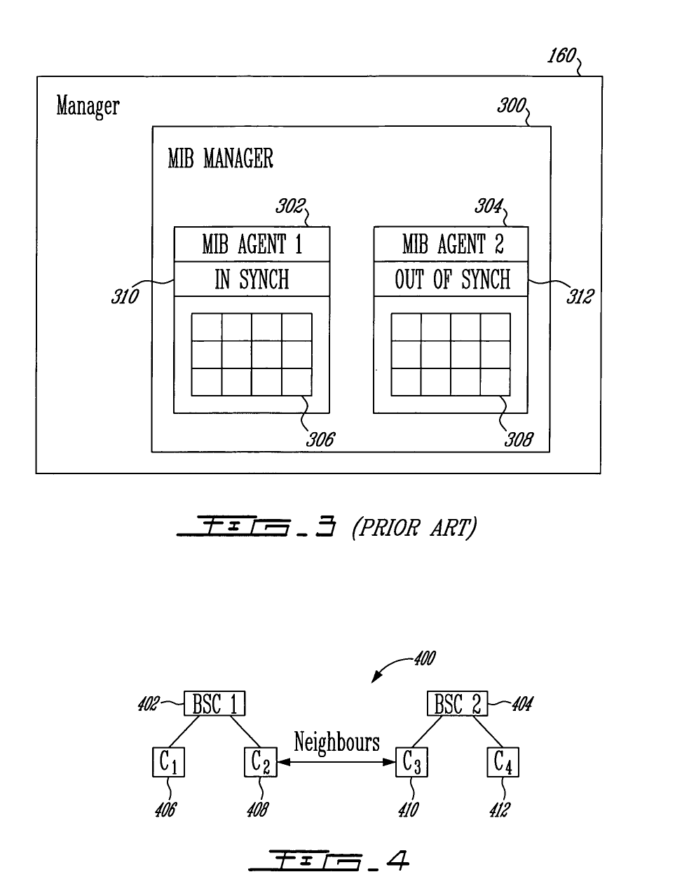

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention provides a method and system wherein synchronization information stored in a Manager's Managed Object (MO) reflects a synchronization status of the Manager with plural Network Elements (NEs) of the managed network. For example, according to the present invention, in the event a change is made to the management information stored in a Manager's (MO) and that this change affects two (2) different NEs of the managed network, such as for example the NE that directly corresponds to the MO and a second NE that neighbors the first NE, the MO propagates the change to the concerned two NEs and expects confirmation of the successful propagation. Upon receipt of successful confirmation from the NE that directly corresponds to the MO, the Manager sets the synchronization status of that MO to “IN SYNCH”, since the management information of the MO is synchronized with the one of the NE following the successful deployment of the change. However, if no successful confirmation is received by the MO from the second NE (the neighbor NE), the Manager sets the synchronization status of the MO that corresponds to the second NE to “OUT-of-SYNCH”, because the second MO could not be synchronized with the latest change performed in the Manager's information.

In order to better understand the present invention, once should first appreciate that instances occur in a management system wherein a change of a given attribute of a given MO that is performed in the Manager may not only affect the managed network's NE corresponding to the given MO, herein called the corresponding NE, but also other NE(s) of the managed network, herein called the related NE(s).

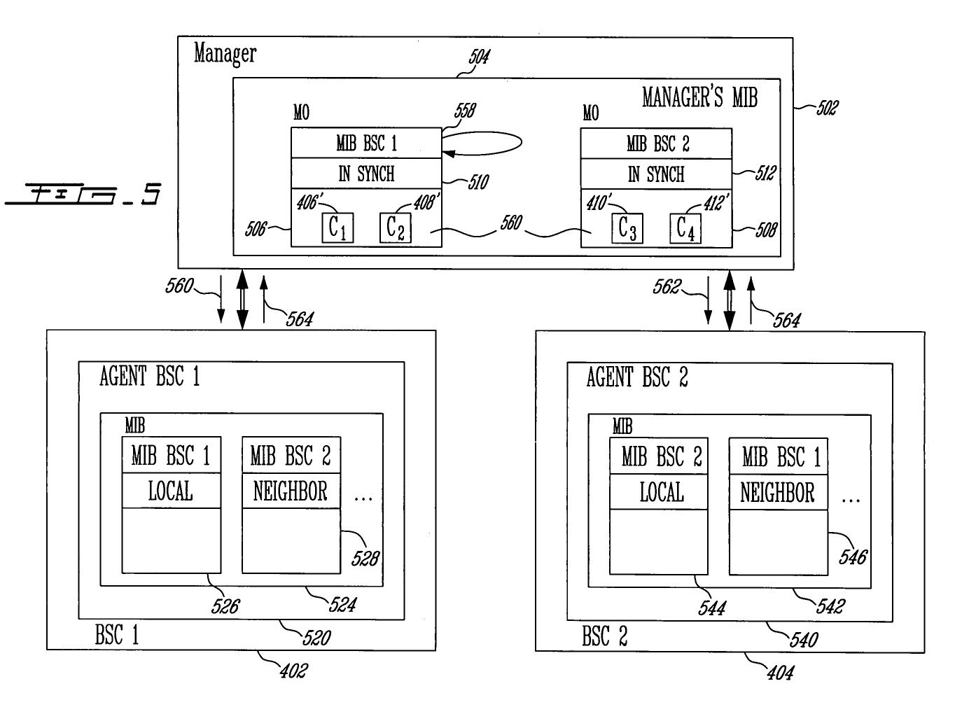

For example, reference is now made to FIG. 4 that shows a high-level representation of two neighboring NEs of a managed network, which in the present exemplary scenario is assumed to be a Public Local Mobile Network (PLMN) 400. Shown in FIG. 4 are two (2) Base Station Controllers (BSCs), BSC 1 402 and BSC 2 404, and four (4) radio cells identified C1-C4 (406-412), although it is understood that many more NEs of the PLMN 400 may exist. It is further assumed that the radio cell C2 408 and the radio cell C3 410 are adjacent (neighbors) in the PLMN 400, so that a Mobile Station (MS) can perform a hand-off from one to the other. In such an instance, changes performed to radio attributes of one such cell also affect the other radio cell since, for example, when performing a hand-off from one cell to the other, the target cell must know and also take into consideration the other cell's radio attributes. Hence, when a system administrator updates, for example, a radio attribute relative to an MO representative of radio cell of the PLMC 400, this change needs not only to be propagated to the corresponding radio cell (the corresponding NE), but also to all its neighbor radio cells (the related NEs).

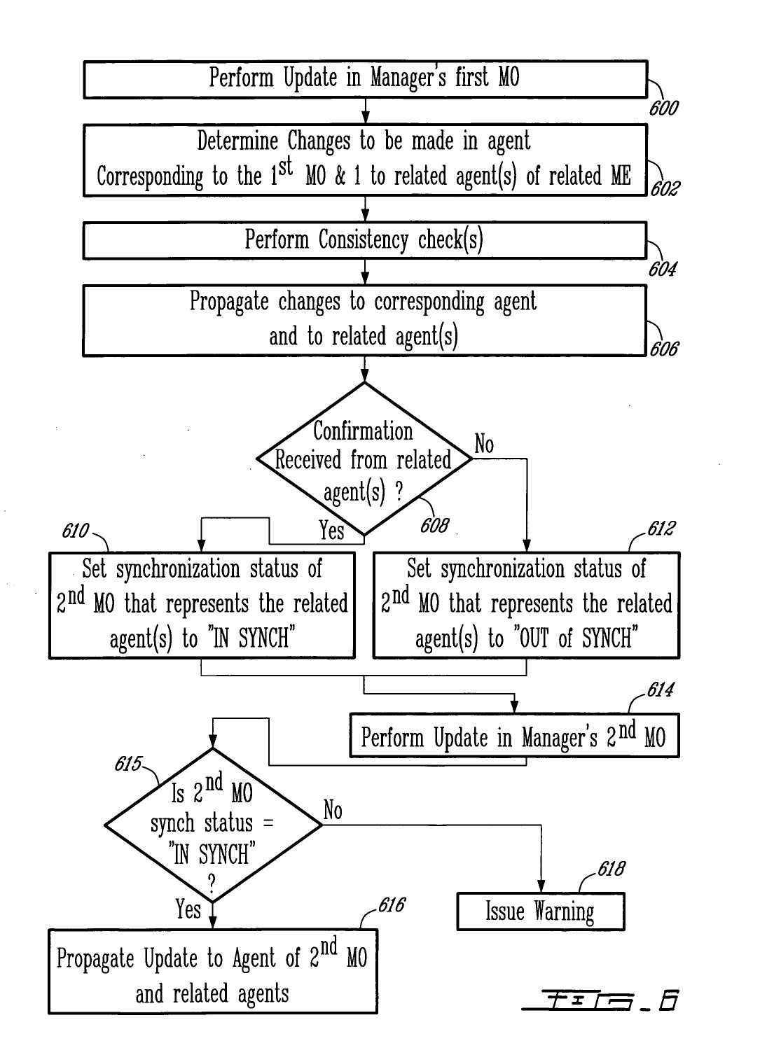

Reference is now made to FIG. 5 which is an exemplary high-level block diagram of a Manager 502 that manages two different NEs 402 and 404 according to the preferred embodiment of the present invention. It is understood that a typical Manager typically comprises many more MOs than the ones shown in FIG. 5. The Manager 502 may be part of a management system (not shown), and comprises a Management Information Base (MIB) 504 for storing management information, including status and configuration information, relative to MOs representative of NEs of the managed network. For example, illustrated in FIG. 5 within the MIB 504 are MOs 506 and 508 that are virtual representations of the NEs BSC 1 402 and BSC 2 404 of the managed network. Each MO of the Manager's MIB 504 comprises synchronization status information 510 and 512 respectively, which is indicative of a synchronization status of the MO with its corresponding NE. For example, when the management information of the MO 506 is synchronized with the management information of its corresponding NE BSC 1 402, the synchronization status 510 of the MO 506 is set to “IN SYNCH”.

Some MOs of the Manager's MIB 504 may also comprise one or more components that may be representative of sub-elements comprised in their corresponding NEs of the managed network. For example, MO 506 may comprise components C1 406′ and C2 408′ representative of the radio cells 406 and 408 respectively that were previously discussed with reference to FIG. 4. Likewise, MO 508 may also comprise components C3 410′ and C4 412′ representative of the radio cells 410 and 412 respectively.

With further reference being made to FIG. 5, at the managed network level are represented the first NE BSC 1 402 and the second NE BSC 2 404, which are assumed to be neighbour BSCs in the PLMN 400, as previously described. The first NE BSC 1 402 comprises its own management Agent 520 responsible for managing and storing management information relative to the BSC 1 402. For this purpose, the Agent 502 comprises its own MIB 524 that may in turn include a local MIB branch 526 with local information relative to the BSC 1 402 itself, such as for example with local configuration information, connections with external NEs, local status information, etc. The MIB 524 may further comprise one or more neighbour NE MIB branch(es) for storing similar management information as the one stored in the local MIB 526, except for the fact that it relates to neighbour NEs, such as for example to the neighbour NE 404. Similarly, the NE BSC 2 404 also comprises its own Agent 540 including its own MIB 542 with a local MIB branch 544 and a neighbour MIB branch 546, relative to the neighbour BSC 1 402.

Because the radio cells 408 and 410 (better shown in FIG. 4) are neighbour NEs in the managed network, so are NEs 402 and 404 too, and hence their virtual representations, i.e. the MOs 506 and 508 of the Manager 502 are also associated as neighbour MOs inside the MIB 504 as well, via association link 560. Such an association link may comprise a reference in the management information of component C2 408′ that refers to fact that the radio cell 408 neighbours the radio cell C3 410.

When a network administrator alters an attribute related to the MO 506 using the Manager 502, action 558, such as for example when an attribute value of the radio cell component 408′ of the MO 506 is updated, that change needs to be deployed to the corresponding NE BSC 1 402 and to the related (neighbor) NE BSC 2 404. For this purpose, the Manager 502 sends update messages 560 and 562 to the two concerned NEs 402 and 404. The NE BSC 1 402 receives the update message 560, updates its local MIB branch 526 with the information of the message 560, and returns a confirmation message 564 to confirm to the Manager 502 the successful update. Responsive to receipt of confirmation message 564, the Manager 502 sets the synchronization status information 510 of the MO 506 to “IN SYNCH” in order to reflect the fact that the latest change performed to the MO 506 has been successfully deployed to the corresponding NE BSC 1 402.

Likewise, the Manager 502 also sends the update message 562 to the related NE BSC 2 404, so that the later can update its neighbor MIB branch 546 with the new attribute changed by the system administrator. However, the transmission of the message 562 may not occur successfully, or the BSC 2 404 may be incapable of successfully updating its MIB branch 546 for various reasons, such as for example because of an internal malfunction like a processor or memory failure. In such a case, the BSC 2 404 returns to the Manager 502 an error message 564 informing the later that a successful update was not performed. Alternatively, the Manager 502 may detect un unsuccessful propagation of the update in absence of any response message from the BSC 2 404. When the Manager 502 detects that no successful update was performed with the BSC 2 404, based on the neighbor association 560, it detects the MO that corresponds to the NE BSC 2 404, which in the present case is the MO 508, and changes its synchronization status 512 to “OUT-of-SYNCH” to reflect the fact that the information of the neighbor MIB branch 546 of the NE 404 is not perfectly synchronized with the latest information of the Manager's MIB 504.

In this manner, the present invention allows a synchronization status of a given MO of a Manager to be altered based not only on its synchronization with its corresponding NE from the managed network, but also based on a synchronization between another related MO (such as for example a neighbor MO) and the NE.

Reference is now made to FIG. 6, which is an exemplary flowchart diagram of a method for updating synchronization status information according to the preferred embodiment of the present invention. The method starts in action 600 where an update of management information is performed in the Manager on a first MO. In action 602, the Manager determines what changes are required in the managed network in order to propagate the first MO update, and identifies the NE's Agent corresponding to the updated MO, as well as one or more related NE Agents which must also be updated with the new information. The related NE Agents may be, for example, Agents of NEs that neighbor the NE that corresponds to the updated MO. In action 604, the Manager may perform consistency check(s) and test the update that needs to be performed against certain internal rules, and in action 606 the Manager propagates the update to the corresponding NE Agent as well as to the identified related NE Agents. The Manager then determines, action 608, if a confirmation of a successful update is received from the related NE Agent(s), and if so, in action 610 it sets the synchronization status of a 2^{nd} MO that represents the related NE Agent which synchronization was successful to “IN-SYNCH”. Otherwise, if the confirmation of a successful update is not received from the related NE Agent, or if an error message is received instead of a successful confirmation message, the Manager sets the synchronization status of the 2^{nd} MO that represents the related NE Agents which synchronization was not successful to “OUT-of-SYNCH”, action 612.

At a later point I time, the system administrator may further perform an update on the 2^{nd} MO, action 614, and the Manager may detect in action 616 the synchronization status of the 2^{nd} MO. If the synchronization status is detected to be “IN SYNCH”, which is representative of a perfect synchronization between the 2^{nd} MO and its corresponding NE of the managed network, the Manager acts, 616, to propagate the update to the corresponding NE and to its related NEs as well, in an action similar to action 606, previously described. Otherwise, if the synchronization status is detected to be “OUT-of-SYNCH”, the Manager acts, 618, to issue a warning for the system administrator informing of the current lack of synchronization between the 2^{nd} MO and its corresponding NE. The purpose of this warning is to inform the system administrator that performing a further update on management information of the MO that is not synchronized with its corresponding NE from the managed network may further complicate a subsequent rectifying synchronization process.

Based upon the foregoing, it should now be apparent to those of ordinary skills in the art that the present invention provides an advantageous solution, which allows for a synchronization status of an MO of a management system to reflect a status of synchronization of its corresponding NE with management information of other MOs. It should be realized upon reference hereto that the innovative teachings contained herein may be implemented advantageously with any applicable radio telecommunications standard for a managed network. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow. For example, although the exemplary scenarios illustrated herein make reference to only two MOs and NEs, it is understood that the invention can be applied to any given number of MOs and NEs of a management system and managed network. Furthermore, although the invention was described as applicable to a scenario wherein the related NEs are neighboring elements of a PLMN, it is apparent that the nature of the NE, as well as the relation between the NEs that need to be updated following a change in a given MO, is not limited thereto. For example, the NEs may be Personal Computer (PCs) or servers of a Local Area Network (LAN), and their relation may be that of cooperating nodes, or a master-slave relation, or any other type of relationship wherein a change performed to attributes of one node also needs to be propagated into another node.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for setting a synchronization status to a Managed Object (MO) of a management system, the method comprising the steps of:
a. changing an attribute of a management system's first MO that represents a first Network Element (NE) of a managed network;
b. responsive to the attribute change, initiating an update of a second NE of the managed network for propagating the change to the second NE, wherein the first and the second NEs are related NEs;
c. determining whether or not the update of the second NE has been completed successfully; and
d. setting a synchronization attribute of the second MO to a value representative of an outcome of the update of the second NE.

2. The method claimed in claim 1, wherein:
step c. comprises the steps: c.1 determining that the update of the second NE has not been completed successfully; and
step d. comprises the step d.1. setting the synchronization attribute of the second MO to a value representative of a lack of synchronization of the second NE.

3. The method claimed in claim 1, wherein the first and second NEs of the managed network are neighbouring NEs and the first and second MOs of the managed system are associated with each other to reflect the neighbouring relationship of the first and second NEs.

4. The method claimed in claim 1, further comprising subsequent to step d. the steps of:
e. changing an attribute of the management system's second MO;
f. determining the synchronization status of the second MO; and
g. if the synchronization status of the second MO is representative of a lack of synchronizing, issuing a warning for informing of a lack of synchronization status of the second MO.

5. The method claimed in claim 1, wherein:
the first and the second MOs are comprised into a Management Information Base (MIB) of a manager of the management system;
step b. comprises initiating by the manager the update of the second NE of the managed network for propagating the change to the second NE;
step c. comprises determining by the manager whether or not the update of the second NE has been completed successfully; and
step d. comprises setting by the Manager a synchronization attribute of the second MO to a value representative of an outcome of the update of the second NE.

6. A manager of a management system comprising:
a first Management Object (MO) that represents a first Network Element (NE) of a managed network;
a second MO that represents a second NE of the managed network, the first and the second NEs being related NEs
wherein when an attribute of the first MO is changed in the manager, the manager initiates an update of the second NE for propagating the change to the second NE, determines whether or not the update of the second NE has been completed successfully, and sets a synchronization attribute of the second MO to a value representative of an outcome of the update of the second NE.

7. The manager claimed in claim 6, wherein:
the manager determines that the update of the second NE has not been completed successfully, and sets the synchronization attribute of the second MO to a value representative of a lack of synchronization of the second NE.

8. The manager claimed in claim 6, wherein the first and second NEs of the managed network are neighbouring NEs and the first and second MOs of the managed system are associated with each other to reflect a neighbouring relationship of the first and second NEs.

9. The manager claimed in claim 6, wherein an attribute of the second MO is further changed, and responsive to the further change, the manager determines the synchronization status of the second MO and, if the synchronization status of the second MO is representative of a lack of synchronizing, the manager issues a warning for informing of the lack of synchronization status of the second MO.

10. The manager claimed in claim 9, further comprising:
a Management Information Base (MIB) that comprises the first and the second MOs.
